(19) United States
(12) Patent Application Publication
(10) Pub. No.: US 2004/0000086 A1
(43) Pub. Date: Jan. 1, 2004

(54) Thermochromatic molded soft plastic baits

(76) Inventors: Britt Wetherington, Boston, GA (US); Tony Odom, Coolidge, GA (US); Richard Bonner, Valdosta, GA (US)

Correspondence Address: Brian D. Bellamy, P.O. Box 1997, Thomasville, GA, 31799-1997, US

(21) Appl. No.: 10/186,551

(22) Filed: Jul. 1, 2002

(51) Int. Cl. A01K 85/00

(52) U.S. Cl. 43/42.24

(57) ABSTRACT

A soft plastic bait for fishing is molded of thermochromatic coloring solution and plastisol resin and changes colors at different water temperatures. The soft plastic bait is made by providing a plastisol with plasticizer to create a plastic resin cold mixed with a chromicolor plastisol concentrate solution. The mixture is cooked and molded and cooled to form a soft plastic bait.

### FIELD OF THE INVENTION

The invention relates to the field of soft plastic baits and, in particular, to soft plastic baits that are molded with a thermochromatic coloring additive, resulting in colored soft baits whose color is temperature dependent.

### BACKGROUND OF THE INVENTION

In the art of fishing lures, it has been taught to apply a special coating to an outer surface of a lure to provide an outer surface which changes color in response to changes in temperature of the water through which the lure is pulled. Such thermochromatic color change has been found advantageous because certain fish that travel within certain depths having particular temperature ranges are more attracted to specific colors. Some of the colors that fish are more attracted to simulate miniature fish or minnows at the particular temperature and depth of water. Further, the changing color of the fishing lure body with changes in the surrounding water temperature also provides the lure with a more animated appearance in order to provide greater attraction to the fish.

Fishing lures are known as hard baits. Whereas, molded baits, such as worms and the like, are referred to in the fishing industry as soft baits. While no existing method provides for soft baits that change color in response to water temperature, hard baits or fishing lures having an outer coating changing color in response to temperature have been disclosed. For example, U.S. Pat. No. 4,731,948 and U.S. Pat. No. 4,835,899 to Doyle D. Helton provides for coating a hard bait with coatings that include a coating having temperature sensitive encapsulated liquid crystals. U.S. Pat. No. 5,222,320 to Nels E. Erickson discusses color changing hard bait fishing lures coated with thermochromatic ink or paint, but Erickson does not mention soft baits that change color in response to temperature. In the Erickson patent, fishing lures are painted with a thermochromatic paint or ink by applying a base coat of white primer then a main coat of a desired hot color and a top coat of a desired cold color that disappears as a particular temperature is reached. The thermochromatic paint is applied to the surface of the hard fishing lure using a three step painting process.

Such processes as revealed by Erickson in the '320 patent are not conducive to preparing soft baits that will change color according to temperature. Soft baits do not provide a hard surface for applying a base coat of primer and the succeeding coats of hot color and cold color. Further, soft baits are flexible and a painted surface on a soft bait would quickly deteriorate or the flexibility and characteristics of the soft bait would be changed by the paint coating. Nonetheless, it would be desirable for the same advantages available for hard baits that change color in response to temperature to be available for soft baits.

### SUMMARY OF THE INVENTION

The invention is a soft plastic bait for fishing that is molded with a thermochromatic concentrate solution additive to produce a soft bait that changes colors at different temperatures. The soft baits provide all of the benefits of hard lures that are coated with thermochromatic paint. However, the combination of a thermochromatic solution with a plastisol used to make a soft bait provides the additional benefits of soft baits used in fishing. Such soft baits include worms, chubs and the like that are attractive to fish in fresh water or salt water. Molding a thermochromatic solution with plastisol used in making soft plastic baits provide soft baits that are even more attractive to certain fish that find the increased animation of the color changing bait attractive or that find a specific color in a specific temperature range of water more attractive.

Thus, it is an object of the invention to provide a soft bait that will change color in response to changing temperature in water.

Another object of the invention is to provide a soft bait that is molded with a thermochromatic coloring agent that will not change the physical texture or quality of the soft bait.

Yet another object is to method for manufacturing a soft bait during the molding process such that the soft bait will change color in response to temperature change in water.

Still another object of the invention is to provide a thermochromatic molded soft plastic bait that can be easily made and have thermochromatic properties throughout the life of the soft plastic bait.

Other objectives of the invention will be apparent to those skilled in the art from the following description and claims.

### DESCRIPTION OF THE DRAWINGS

FIG. 1 is a scale of color change versus temperature for a soft bait made having thermochromatic properties in accordance with the present invention. The figure shows a soft bait indicative of soft baits used in fresh water such as plastic worms.

FIG. 2 is a scale of color change versus temperature for a soft bait indicative of soft baits used in salt water such as plastic chubs.

### DETAILED DESCRIPTION OF THE INVENTION

The present invention provides a soft plastic bait 2 that changes color in response to temperature change. The color changing plastic bait is manufactured by combining a thermochromatic solution with plastisol. Several thermochromatic coloring solutions of various color design may be added together to create new specific color combinations such that the plastic bait responds by changing color in accordance with the combination when encountering temperature change.

Two types of thermochromatic coloring solutions are known. A first type of thermochromatic coloring solution, referred to herein as type A, changes from one color to another at a given temperature and remains that color until it returns to normal. A second type of thermochromatic coloring solution, referred to herein as type B, changes from one color to another at a give temperature like the type A solution. However, the type B solution changes back to its original color at a specific temperature upon encountering even further temperature change. The type A and type B solutions can be combined together into a mixture with plastisol to provide an infinite number of color changes and color reversions according to water temperature. The colors that the coloring solutions change to and from are referred to as the hot color and cold color.

The thermochromatic coloring solution used in the present invention is a concentrate solution for plastisol, which is also known as chromicolor PVC concentrate solution or chromicolor plastisol concentrate solution. A chromicolor plastisol concentrate solution in paste form designed for use in rotocast and slush molding processes has been found suitable, but equivalent solutions in liquid, gel, powder, solid or other form could be used in the molding process used in making plastic baits.

The chromicolor plastisol concentrate solution, referred to in portions of the description hereinafter as the concentrate, is a form of concentrate that has been found to work well with the PVC or plasticizer, as used in molding plastic baits. The particular concentrate used is designed for use with plastisol and is not compatible with materials such as wood, glass, metal, or cloth. Further, the concentrate used is not compatible with white pigment and the use of white primer as a base coat of paint. Whereas white paint is generally used to provide a base coat in applications of thermochromatic coloring to hard baits and the like, white paint cannot be used with the soft plastic baits disclosed by the present invention.

The plastic baits made in accordance with the present invention use a popular polymer known as plastisol that is used in a variety of plastic products. In order to arrive at a set of desired properties appropriate for plastic baits, the plastisol polymer is combined with other ingredients or additives. One additive, plasticizer, is used to change the chemical composition and molecular size of the plastisol polymer to create desirable properties of the plastic bait. Plasticizers can also change the flammability, odor, biodegradability, and flexability of the polymer. For example, PVC (polyvinyl chloride) used in many different forms such as vinyl siding on a home is not plasticized and therefore rigid. Whereas, plasticized PVC is suitable for making garden hoses, which are flexible and much different in molecular structure that the vinyl siding. Thus, plasticizer is added to the plastisol to create a plastic resin that is used in molding and creating a final product consisting of the soft and flexible plastic bait.

In making the plastic bait having thermochromatic color properties, the plastic resin is mixed with the preselected thermochromatic coloring solution or concentrate. The concentrate is cold mixed with the plastic resin which comprises a matrix. To create a mixture that is translucent in appearance, the preferred ratio of concentrate to plastic resin has been determined to have a range of about 1 part concentrate to 5 parts resin to about 1 part concentrate to 3 parts resin. Thus, the concentrate will ultimately constitute about 20 to 33 percent of the overall composition of the soft plastic bait.

After the concentrate and resin are combined, the combination is cooked very slowly to a temperature of approximately 350 degrees Fahrenheit. The cooking process changes the chemical composition of the liquid plastic resin and sets the thermochromatic coloring solution in the plastic. During the cooking process constant mixing is required to ensure uniform distribution of the concentrate and uniform cooking. The plastic resin is greatly affected by the temperature and length of time it is held at a temperature of 350 degrees Fahrenheit or more. The correct mixture of concentrate and resin and the correct heating to 350 degrees Fahrenheit will produce a soft plastic that is translucent. If not properly mixed or cooked, the resulting plastic will be opaque or have the wrong hardness for soft plastic baits.

Once the plastic has been heated to about 350 degrees, the plastic is poured or injected into a mold of a specific shape. The plastic cools in the mold to shape the plastic in the form of the desired soft bait of varieties for fresh water or salt water. Once the plastic has cooled completely, it is removed from the mold and retains the shape of the mold. If correctly heated and processed, the plastic bait will retain a soft plastic texture and will also have the ability to change colors from the hot color to the cold color or vice versa. The color change will be in accordance to the colors selected and the thermochromatic coloring solution type selected, including the Type A or Type B coloring solution as described hereinbefore.

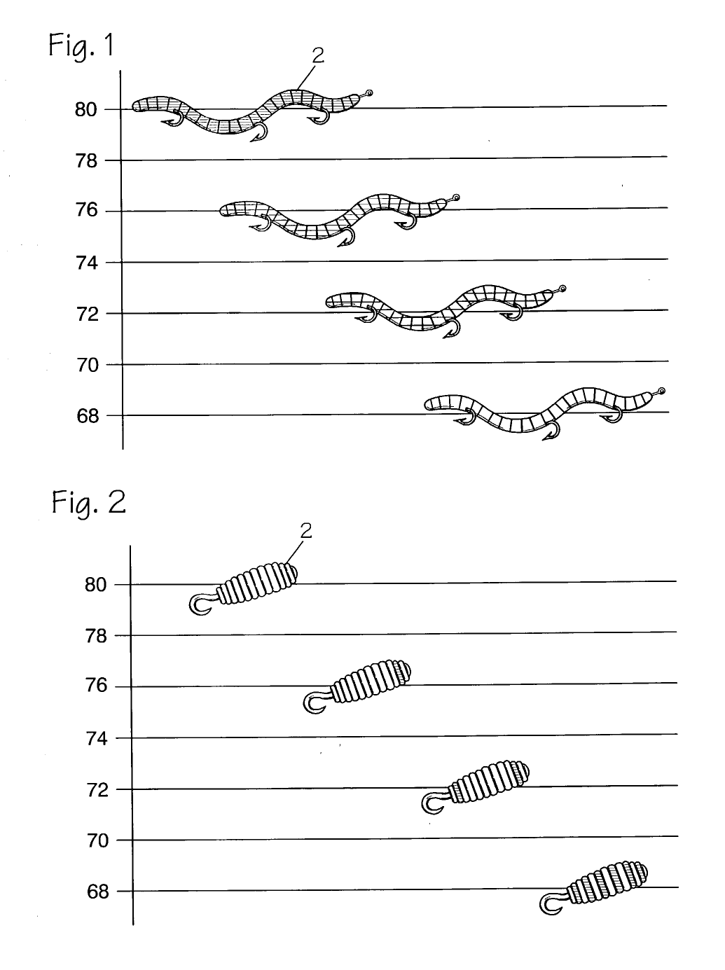

The thermochromatic coloring solution type selected is the controlling factor in determining the temperature at which the soft plastic bait will change color. Referring to the figures, FIGS. 1 and 2 illustrate one possible scale of color change versus temperature for a soft bait made having thermochromatic properties in accordance with the present invention. FIG. 1 shows a soft bait indicative of soft baits used in fresh water such as plastic worms, and FIG. 2 shows a soft bait indicative of soft baits used in salt water such as plastic chubs. As illustrated, the soft bait changes from its initial warm color at 80 degrees Fahrenheit to its cold color at 68 degrees Fahrenheit. Over the entire scale between 80 and 68 degrees, the color will usually show some gradual change between the two temperatures resulting in a more animated appearance for the soft bait.

Although most fish do not change color due to the temperature of the water, fish do change color in accordance with the amount of light that penetrates the water. Generally, the more light that penetrates the water, the warmer that water will be, and the less light that penetrates the water, the cooler that water will be. Likewise, thermoclines causing water to become cooler usually occur some distance below the warmer surface waters where light penetration has decreased. Thus, some correlation exists between light penetration into water and the temperature of that water. The thermochromatic soft plastic bait herein changes color with temperature, and this color change may be coordinated with the correlation between the amount of change in light penetration and resulting temperature change expected in water. Having designed a thermochromatic soft bait coordinated with the correlation between light penetration and temperature change, the soft bait will mimic the natural color change of a live fish or bait in the water. Of course, the thermochromatic properties of the soft bait may be provided without coordination with light and temperature to simply provide a very animated soft bait, or one that provides a fisherman an greater opportunity to find the color of bait that is attractive to fish in the local area.

The thermochromatic soft plastic baits may provide various effects on the overall look of the soft bait by the process of applying the matrix. Striping as well as multiple color combinations may be use together to create special effects, and color change can range from colorless to any color available. The color change provided may be temporary, long-lasting, or permanent. And, the thermochromatic soft bait can be designed to revert to its original color after additional temperature change. The potential animation and combinations is extensive.

The soft bait described in accordance with the invention has unique attributes not available with hard baits or lures. With the soft bait herein, the thermochromatic coloring solution is a part of the plastic compound forming the soft bait, whereas prior hard baits or lures have had the color changing solution sprayed or baked onto the surface of the lure. Lures have been limited to surface applications of coatings having thermochromatic properties, and surface coatings are prone to chipping, cracking, abrasions, and fading that deteriorate the quality of the color changing effect. Further, thermochromatic surface coatings generally require a coat of white primer paint, which further limits the variety of thermochromatic color changing properties and also inhibits flexibility in designing the hard bait. By providing a plastic compound for a soft bait in which the entire soft bait changes colors, the soft bait avoids the deterioration of its color changing features and feasiblely provides for the extensive thermochromatic color variation described.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

We claim:

1. An improved soft plastic bait for fishing comprising a molded plastisol resin in combination with a thermochromatic coloring solution wherein the soft plastic bait changes colors in response to change in water temperature.

2. An improved soft plastic bait for fishing as set forth in claim 1 in which said thermochromatic coloring solution is chromicolor plastisol concentrate solution.

3. An improved soft plastic bait for fishing as set forth in claim 1 in which said plastisol resin includes plasticizer to change the chemical composition and molecular size of the plastisol polymer to create desirable properties of softness and flexibility of said soft plastic bait.

4. An improved soft plastic bait for fishing as set forth in claim 1 in which said thermochromatic coloring solution comprises between 20 percent to 33 percent of said combination of the plastisol resin with the thermochromatic coloring solution.

5. A method of making a soft plastic bait for fishing that changes colors in response to change in water temperature including the steps of:
a. providing a plastisol suitable for the manufacture of soft plastic baits;
b. adding a plasticizer to the plastisol to create a plastic resin;
c. providing a chromicolor plastisol concentrate solution;
d. cold mixing the chromicolor plastisol concentrate solution with the plastic resin to create a matrix;
e. slowly cooking the matrix to a temperature of 350 degrees Fahrenheit to change the chemical composition of the plastic resin and to set the chromicolor plastisol concentrate solution in the plastic resin whereby a plastic is formed, while constantly mixing the matrix to ensure uniform distribution of the chromicolor concentrate solution and uniform cooking;
f. pouring or injecting the plastic into a mold;
g. cooling the plastic in the mold to shape the plastic into the form of the soft plastic bait.

6. A method of making a soft plastic bait for fishing that changes colors in response to change in water temperature as set forth in claim 5 in which said step of cold mixing the chromicolor plastisol concentrate solution with the plastic resin to create the matrix includes adding one part chromicolor plastisol concentrate solution per three to five parts of plastic resin.
